(19) United States
(12) Patent Application Publication
(10) Pub. No.: US 2010/0051439 A1
(43) Pub. Date: Mar. 4, 2010

(54) HANDLE FOR THE REMOTE CONTROL OF A MOVING VEHICLE, PARTICULARLY A CIVIL ENGINEERING WORKS VEHICLE, AN AGRICULTURAL OR HANDLING VEHICLE

(75) Inventor: Didier Merletti, Saint Sorlin (FR)

Correspondence Address: CANTOR COLBURN, LLP, 20 Church Street, 22nd Floor, Hartford, CT, 06103, US

(73) Assignee: Bosch Rexroth D.S.I., Venissieux (FR)

(21) Appl. No.: 12/439,904

(22) PCT Filed: Jul. 10, 2007
(86) PCT No.: PCT/FR2007/001184

§ 371 Date: Oct. 5, 2009

(30) Foreign Application Priority Data
Sep. 5, 2006 (FR) 06.07779

(51) Int. Cl. H01H 21/00

(52) U.S. Cl. 200/6 A

(57) ABSTRACT

The handle for the remote control of a moving vehicle, particularly a civil engineering works vehicle, an agricultural vehicle or handling vehicle according to the invention comprises a control device of the proportional type (4) including an actuating part (5) that is able to move relative to a body (6) integral with the handle, and return means (11) for returning the actuating part (5) to a rest position. The handle additionally comprises a control device of the all-or-nothing type (7), memory storage means (8) for storing a value of a signal originating from the proportional control device, and signal processing means (9) for processing the signals from the proportional control device (4) and from the all-or-nothing control device (7), the processing means (9) supplying a member of the moving vehicle, outside of the handle, with an output signal the value of which corresponds, according to a first mode of operation, to the value of the output signal from the proportional control device (4) and, according to a second mode of operation, to a value of a signal form the memory storage means (8), the switch of the processing means (9) from a first to a second mode of operation being commanded by the signal from the all-or-nothing control device (7).

### TECHNICAL FIELD OF THE INVENTION

The present invention relates to a handle for a remote control of a movable machine, in particular a construction machine, an agricultural or materials handling machine.

### BRIEF DESCRIPTION OF RELATED ART

It is known practice, according to document US 2006/0007144, to produce such a handle so that it comprises a control device of the proportional type comprising an actuation portion that can be moved relative to a body secured to the handle, and means for returning the actuation portion to a rest position.

The handle described in document US 2006/0007144 also comprises:
a control device of the open-shut type,
means for processing signals originating from the proportional control device and from the open-shut control device,

processing means supplying to a member of the movable machine, outside the handle, an output signal the value of which corresponds, according to a first operating mode, to the value of the output signal of the proportional control device.

The proportional control device makes it possible to control a member of the machine outside the remote control.

One and the same member may be fitted with different implements. These implements may require a permanent control of the operator, for object-handling operations for example, or may simply require the generation of a setpoint value to carry out the given operation. For example, it may be desirable to adapt a particular implement to a member in order to produce a mixture of concrete. In this case, it is sufficient to give a setpoint value to control a rotation speed of the mixer.

It is desirable in these conditions to release the operator while the operation continues in order to prevent him having to maintain a pressure on a control device.

It is also known, according to document U.S. Pat. No. 5,160,918, to produce a handle for a movable machine remote control that is able to maintain an output signal when the operator desires, even after the handle has ceased to be moved. The transition into this operating mode of the handle is carried out when the handle is held in one and the same position for at least a predetermined period. In this case, the output signal is immobilized on a value corresponding to the position of the handle until the handle is moved again into this position or until it is moved into an opposite position.

When the handle according to document U.S. Pat. No. 5,160,918 comprises a control device of the proportional type, it becomes difficult for a user to hold the handle perfectly in an intermediate position for a predetermined period. Specifically, a slight movement of the user's hand could result in a movement of the handle before the expiry of the predetermined period, which would prevent the desired holding of the output signal.

One possibility for avoiding this disadvantage could consist in reducing the period during which the remote control must be immobilized in order to switch into the operating mode making it possible to hold the output signal, even after the handle has ceased to be moved. However, such a reduction could result in a transition into this operating mode when the user does not desire it.

### BRIEF SUMMARY OF THE INVENTION

The technical problem at the basis of the invention is therefore to propose a handle making it possible to easily generate a control signal of the proportional type without permanent action of the operator on the handle.

Accordingly, the subject of the present invention is a remote control handle of the first type aforementioned, characterized in that the handle comprises means for storing in memory a value of a signal originating from the proportional control device, and in that the processing means supply to a member of the movable machine, outside the handle, an output signal of which the value corresponds, according to a second operating mode, to a value of a signal originating from the memory storage means, the transition from a first to a second operating mode of the processing means being controlled by the signal originating from the open-shut control device.

The arrangements according to the invention make it possible to produce in the remote control handle a function for holding a setpoint value to control a member outside the remote control, and therefore to release the operator from the task consisting in maintaining a pressure on the control device.

Preferably, the transition from the first to the second operating mode is occasioned when the open-shut control device is actuated for a determined period of time.

These arrangements make it possible to ensure that the transition from the first to the second mode is effectively desired by the operator and that the control device has not been actuated in error for example by knocking this device accidentally.

Advantageously, the memory storage means record the value of a signal originating from the proportional control device during the transition from the first to the second operating mode.

Preferably, the transition from the second operating mode to the first operating mode is authorized only if the proportional control device is in the rest position.

These arrangements make it possible to ensure that no control is supplied to the outside member during the return to the first mode.

Advantageously, the transition from the first operating mode to the second operating mode is authorized only if the proportional control device is in a position distinct from the rest position.

These arrangements prevent a void control signal being communicated to the outside member in the second operating mode.

Preferably, the handle comprises a casing delimiting internally a cavity in which the signal processing means and the memory storage means are housed.

This handle structure makes it possible to easily house the processing and memory storage means in the handle.

According to a first possibility, the signal processing means consist of a microprocessor.

Advantageously, the microprocessor includes the memory storage means.

Preferably, the handle comprises an electronic power card converting the output signal of the processing means into a higher power signal, the electronic card comprising the processing means.

According to another possibility, the processing means consist of analog means.

Advantageously, the handle comprises display means designed to inform a user on the operating mode of the processing means.

Preferably, the display means comprise a lamp indicator.

Advantageously, the processing means and the memory storage means are protected by a layer of resin.

At all events, the invention will be well understood with the aid of the following description, with reference to the appended schematic drawings representing, as a nonlimiting example, one embodiment of an item of equipment according to the invention.

### BRIEF DESCRIPTION OF THE DRAWINGS

FIG. 1 is a schematic view in section of a handle according to the invention.

FIG. 2 is a diagram of the control and signal processing devices of the handle, in a first operating mode.

### DESCRIPTION OF THE PREFERRED EMBODIMENTS

FIG. 3 is a diagram of the control and signal processing devices of the handle in a second operating mode.

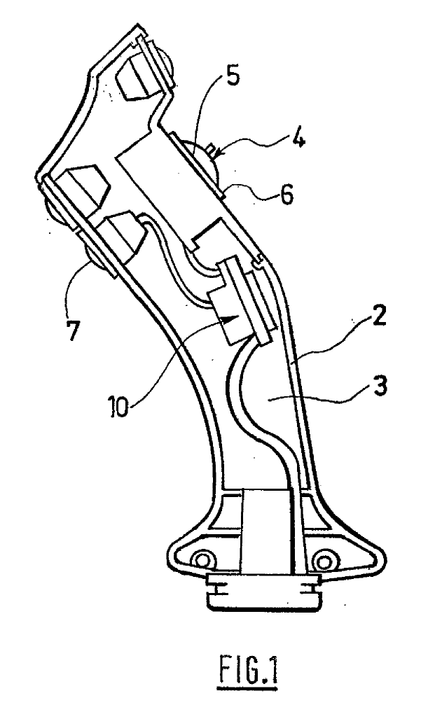

According to one embodiment represented in FIGS. 1 to 3, a handle for a remote control of a movable machine according to the invention comprises a casing 2 delimiting internally a cavity 3.

On this casing 2 a first rotary control device 4 of the proportional type is attached comprising an actuation portion 5 that can be moved relative to a body 6 secured to the casing 2 of the handle, and comprising means for returning the actuation portion to a rest position.

The handle also comprises a control device of the open-shut type, consisting for example of a button 7.

Inside the cavity 3 of the casing 2 are housed:
means 8 for storing in memory a value of a signal originating from the proportional control device 4, and
means 9 for processing signals originating from the proportional control device 4 and from the open-shut control device 7, consisting of a microprocessor with a memory programmed for this purpose.

The microprocessor is incorporated into an electronic power card 10 housed in the cavity, this card converting the output signal of the processing means 9 into a higher power signal.

Advantageously, the electronic card 10 is protected by a layer of resin not shown.

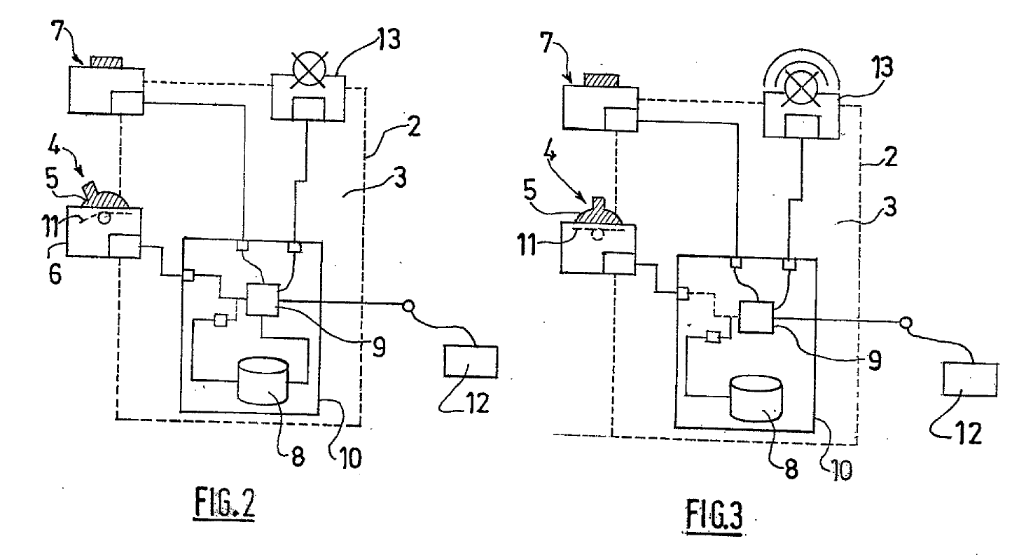

The processing means 9 supply to a member 12 of the movable machine, outside the handle, an output signal the value of which corresponds:
to the value of the output signal of the proportional control device 9 or to a signal derived from this output signal, according to a first operating mode, represented in FIG. 2, and
to a value of a signal originating from the memory storage means 8, according to a second operating mode represented in FIG. 3.

The transition from a first to a second operating mode of the processing means 9 is controlled by the signal originating from the open-shut control device 7.

The transition from the first to the second operating mode is caused when the open-shut control device 7 is actuated for a determined period of time. For example, the signal of the control device 7 must be at a high level for 0.5 s.

Other conditions may be provided for carrying out this transition for example with the proportional control device 4 being in a position distinct from the rest position.

The recording of the signal value originating from the proportional control device 4 in the memory storage means 8 is carried out in response to the transition from the first to the second operating mode.

The transition from the second to the first operating mode is occasioned when the open-shut control device 7 is again actuated for a determined period of time. For example, the signal of the control device must be at a high level for 0.5 s. Naturally, the transitions from the first mode to the second mode and from the second mode to the first mode may be carried out for different periods of time.

Other conditions may be provided for achieving the transition from the second to the first operating mode, for example for the proportional control device 4 to be in the rest position.

Display means 13, consisting of a lamp indicator, for example a light-emitting diode controlled by the processing means, inform a user on the operating mode in which the processing means are. For example, the indicator may be off in the first operating mode and on in the second operating mode.

According to a variant not shown, the processing means consist of analog means.

According to a variant not shown, the processing means may be supported by an electronic card comprising no power component, the signal being amplified outside the handle, for example at the member to be controlled belonging to the movable machine.

As it goes without saying, the invention is not limited to the preferred embodiment described above as a nonlimiting example; on the contrary, it covers all the variants thereof.

1. A handle for a remote control of a movable machine, in particular a construction machine, an agricultural or materials handling machine, comprising:
a control device of the proportional type comprising an actuation portion that can be moved relative to a body secured to the handle,
means for returning the actuation portion to a rest position,
a control device of the open-shut type,
means for processing signals originating from the proportional control device and from the open-shut control device,
the processing means supplying to a member of the movable machine, outside the handle, an output signal the value of which corresponds, according to a first operating mode, to the value of the output signal of the proportional control device,
which handle comprises means for storing in memory a value of a signal originating from the proportional control device, and in that the processing means (9) supply to a member of the movable machine, outside the handle, an output signal of which the value corresponds, according to a second operating mode, to a value of a signal originating from the memory storage means, the transition from a first to a second operating mode of the processing means being controlled by the signal originating from the open-shut control device.

2. The handle as claimed in claim 1, wherein the transition from the first to the second operating mode is occasioned when the open-shut control device is actuated for a determined period of time.

3. The handle as claimed in claim 1, wherein the memory storage means record the value of a signal originating from the proportional control device during the transition from the first to the second operating mode.

4. The handle as claimed in claim 1, wherein the transition from the second operating mode to the first operating mode is authorized only if the proportional control device is in the rest position.

5. The handle as claimed in claim 1, wherein the transition from the first operating mode to the second operating mode is authorized only if the proportional control device is in a position distinct from the rest position.

6. The handle as claimed in claim 1, further comprising a casing delimiting internally a cavity in which the signal processing means and the memory storage means are housed.

7. The handle as claimed in claim 1, wherein the signal processing means a microprocessor.

8. The handle as claimed in claim 7, wherein the microprocessor includes the memory storage means.

9. The handle as claimed in claim 7, further comprising an electronic power card converting the output signal of the processing means into a higher power signal, the electronic card comprising the processing means.

10. The handle as claimed in claim 1, wherein the processing means comprises analog means.

11. The handle as claimed in claim 1, further comprising display means designed to inform a user on the operating mode of the processing means.

12. The handle as claimed in claim 11, wherein the display means comprise a lamp indicator.

13. The handle as claimed in claim 1, wherein the processing means and the memory storage means are protected by a layer of resin.
